(19) United States
(12) Patent Application Publication
(10) Pub. No.: US 2018/0023366 A1
(43) Pub. Date: Jan. 25, 2018

(54) Slotted Backup Ring Assembly

(71) Applicant: Baker Hughes, a GE company, LLC, Houston, TX (US)

(72) Inventors: Guijun Deng, The Woodlands, TX (US); John K. Wakefield, Cypress, TX (US); Adam Patterson, Richmond, TX (US); Alexander M. Kendall, Houston, TX (US)

(73) Assignee: Baker Hughes, a GE company, LLC, Houston, TX (US)

(21) Appl. No.: 15/649,363

(22) Filed: Jul. 13, 2017

Related U.S. Application Data
(63) Continuation-in-part of application No. 14/989,199, filed on Jan. 6, 2016.

(51) Int. Cl. E21B 33/12; F16J 15/02; E21B 43/26; E21B 33/128; E21B 43/14

(52) U.S. Cl. CPC E21B 33/1216; E21B 33/128; E21B 43/14; E21B 43/26; F16J 15/028

(57) ABSTRACT

A unique backup ring against ends of a sealing element features axial slots extending part way along a cylindrical segment of the backup ring. The slots end in rounded openings to relieve stress and a part of the cylindrical shape of the backup ring is solid. The slotted end of the cylindrical portion is tapered in section toward the end overlapping the sealing element. The face of the backup ring away from the sealing element is tapered and rides on an adjacent tapered surface away from the mandrel during the setting. The tapered seal end of the backup ring bends to reach the surrounding tubular before the balance of the cylindrical portion reaches the surrounding tubular. Extrusion along the mandrel is stopped by a mandrel seal on an adjacent wedge ring. The mandrel end of the backup ring has a peripheral stiffener to lend rigidity.

### CROSS REFERENCE TO RELATED APPLICATION

This application is a Continuation-in-Part and claims priority to U.S. application Ser. No. 14/989,199 filed on Jan. 6, 2016.

### FIELD OF THE INVENTION

The field of the invention is sealing systems for subterranean tools against tubular or open hole or cased hole and more particularly backup rings that are disposed at opposed ends of a sealing element assembly to contain the sealing element against axial extrusion.

### BACKGROUND OF THE INVENTION

In the unconventional drilling and completion industry, oil and gas deposits are often produced from tight reservoir formations through the use of fracturing and frack packing methods. To frack a well involves the high pressure and high velocity introduction of water and particulate media, typically a sand or proppant, into the near wellbore to create flow paths or conduits for the trapped deposits to flow to surface, the sand or proppant holding the earthen conduits open. Often, wells have multiples of these production zones. Within each production zone it is often desirable to have multiple frack zones. For these operations, it is necessary to provide a seal known as a frack packer, between the outer surface of a tubular string and the surrounding casing or borehole wall, below the zone being fractured, to prevent the pumped fluid and proppant from travelling further down the borehole into other production zones. Therefore, there is a need for multiple packers to provide isolation both above and below the multiple frack zones.

A packer typically consists of a cylindrical elastomeric element that is compressed axially, or set, from one end or both by gages within a backup system that cause the elastomer to expand radially and form a seal in the annular space. Gages are compressed axially with various setting mechanisms, including mechanical tools from surface, hydraulic pistons, atmospheric chambers, etc. Setting typically requires a fixed end for the gages to push against. These fixed ends are often permanent features of a mandrel but can include a dynamic backup system. When compressed, the elastomeric seal has a tendency to extrude past the gages. Therefore, anti-extrusion backups have become common in the art. However, typical elastomeric seals maintain the tendency to extrude through even the smallest gaps in an anti-extrusion backup system.

In cased-hole applications, anchoring of compression set packers is a common feature in the completion architecture. Anchoring is provided by wedge-shaped slips with teeth that ride up ramps or cones and bite into the casing before a packer is set. These systems are not part of the backup system nor are they designed to provide anti-extrusion. Often they are used in the setting of the packer to center the assembly which lowers the amount of axial force needed to fully set the elastomer seal. Once set, anchoring systems are also useful for the life of the packer to provide a uniform extrusion gap, maintain location and help support the weight of a bottom-hole assembly in the case of coiled tubing frack jobs. Anchors also prevent tube movement in jointed strings resulting from the cooling of the string by the frack fluid. Movement of the packers can cause them to leak and lose seal.

In open-hole frack pack applications it is rarer for the packer to have anchoring mechanisms, as the anchor teeth create point load locations that can overstress the formation, causing localized flow paths around the packer through the near well-bore. However, without anchors, movement from the base pipe tubing can further energize the elastomeric seal. Energizing the seal from tube movement tends to overstress the near wellbore as well, leading to additional overstressing of the wellbore, allowing communication around the packer, loss of production, and potential loss of well control to surface. However, the art of anchoring has been reintroduced in new reservoirs in deep-water open-hole fracking operations. The current state of the art in open-hole frack pack operations requires a choice between losing sealing due to anchor contact induced fractures, packer movement, or over-energizing of the elastomeric element.

Extrusion barriers involving tapers to urge their movement to block an extrusion path for a sealing element have been in use for a long time as evidenced by U.S. Pat. No. 4,204,690. Some designs have employed tapered surfaces to urge the anti-extrusion ring into position by wedging them outwardly as in U.S. Pat. No. 6,598,672 or in some cases inwardly as in U.S. Pat. No. 8,701,787. Other designs simply wrap thin metal rings at the extremities of the sealing element that are designed to contact the surrounding tubular to create the anti-extrusion barrier. Some examples of these designs are U.S. Pat. No. 8,479,809; U.S. Pat. No. 7,708,080; US 2012/0018143 and US 2013/0147120. Of more general interest in the area of extrusion barriers are U.S. Pat. No. 9,140,094 and WO 2013/128222.

These solid rings used in the past against the ends of the sealing element assembly still had issues with preventing axial extrusion and provided a great deal of resistance in the setting process. Accordingly, a backup ring with axial slots having rounded ends was developed where the slots go part way down the cylindrical portion of the backup ring assembly and the cross-sectional shape of the cylindrical portion is tapered down in a direction toward the free end of the cylindrical portion. The face opposite the contact face with the sealing element is abutted to a sloping surface to allow the backup ring to ride up radially away from the mandrel during the setting. The tapered segment flexes toward the surrounding tubular during setting movement and the remainder of the cylindrical portion then arrives to contact the surrounding tubular. The non-slotted portion of the cylindrical shape acts as a barrier against the surrounding tubular. A seal on an adjacent wedge ring that is against the mandrel ultimately stops axial extrusion along the mandrel.

In some applications the gap across which the seal is expected to function is quite large placing such applications beyond the limits of the design in U.S. Pat. No. 6,598,672. There is a need for an extended reach design that can withstand the pressure differentials. This need is addressed with a wedge shaped extrusion ring assembly that, depending on the gap to be spanned is pushed on opposing ramps along a pedestal ring for extended reach when contacted by an outer support ring. To fixate the extrusion ring in the extended position an outer support ring also moves into contact with the extrusion ring in its extended position on the pedestal ring. In the extended reach configuration of the extrusion ring, the backup ring moves part way toward the surrounding tubular or borehole. In shorter reach applications the extrusion ring can move out to the surrounding tubular or borehole wall on one side of the pedestal ring and the outer support ring is eliminated. The backup ring is wedged against the surrounding borehole wall to allow it to act as an anchor for the plug that has the sealing system. In the extended reach configuration the reaction forces from the extrusion ring are directed into the abutting backup ring and into the setting system so that the backup ring is prevented from being squeezed out of its wedged position against the pedestal ring. The present invention is focused on the extrusion ring abutting the ends of the sealing element and the various features and movement of that ring to provide reliable barrier against extrusion along the borehole wall. These and other aspects of the present invention will be more readily apparent to those skilled in the art from a review of the description of the preferred embodiment and the associated drawings while understanding that the hall scope of the invention is to be found in the appended claims.

### SUMMARY OF THE INVENTION

A sealing element is flanked by wedge-shaped extrusion ring assemblies. The extrusion rings are continuous for 360 degrees and are slotted from the outside dimension and alternatively from the inside dimension to allow the diameter to increase to the surround tubular or open hole. The extrusion rings climb a ramp on an adjacent pedestal ring on the way out to the borehole wall. Depending on the dimension of the gap to be spanned the extrusion ring slides a variable distance up the pedestal ring ramp. An optional anchor ring is initially forced up an opposite ramp of the pedestal ring. If the sealing gap is short the anchor ring can be eliminated. For larger gaps the anchor ring moves out far enough toward the borehole wall to contact the extrusion ring located on an opposing ramp of the pedestal ring so that reaction forces are directed to keep the anchor ring wedged in position for support of the extrusion ring assembly.

A unique backup ring against ends of a sealing element features axial slots extending part way along a cylindrical segment of the backup ring. The slots end in rounded openings to relieve stress and a part of the cylindrical shape of the backup ring is solid. The slotted end of the cylindrical portion is tapered in section toward the end overlapping the sealing element. The face of the backup ring away from the sealing element is tapered and rides on an adjacent tapered surface away from the mandrel during the setting. The tapered seal end of the backup ring bends to reach the surrounding tubular before the balance of the cylindrical portion reaches the surrounding tubular. Extrusion along the mandrel is stopped by a mandrel seal on an adjacent wedge ring. The mandrel end of the backup ring has a peripheral stiffener to lend rigidity.

### BRIEF DESCRIPTION OF THE DRAWINGS

FIG. 1a is a prior art perspective view of split extrusion rings keyed together with splits opposed at 180 degrees shown in the run in condition;

FIG. 1b is the view of FIG. 1a in the expanded condition showing the size increase for the split in the adjacent rings;

FIG. 2 is a section view in the run in position for a long reach embodiment;

FIG. 3 is the view of FIG. 2 in the set position;

FIG. 4a is a perspective view of the extrusion ring in the run in position;

FIG. 4b is the view of FIG. 4a in the set position;

FIG. 5 is a side view of a backup ring that is located next to a sealing element;

FIG. 6 is a perspective view of an optional anchoring ring shown in the run in condition;

FIG. 7 is a section view of a short reach embodiment in the run in position;

FIG. 8 is the view of FIG. 7 in the set position;

FIG. 9 is a perspective view of FIG. 3;

FIG. 10 is a section view of the backup showing its axial slots;

FIG. 11 is a perspective view of the ring of FIG. 10;

FIG. 12 is a section view of a sealing assembly with the backup ring of FIG. 10 in the run in position;

FIG. 13 is the view of FIG. 12 during the setting;

FIG. 14 is the view of FIG. 13 after the setting is complete;

FIG. 15 is a detailed view of circle D in FIG. 14;

FIG. 16 is an outside view of the assembly shown in FIG. 12.

### DETAILED DESCRIPTION OF THE PREFERRED EMBODIMENT

To appreciate the benefits of the present invention it is necessary to review the state of the art in compression set element extrusion barriers. The sealing element design is typically one or more rubber sleeves that are axially compressed against a surrounding tubular. Extrusion barriers can be one or more layers of flexible thin sheet located at an end of a sealing assembly. As the sealing element deforms due to axial compression the extrusion barrier rings such as item 64 in U.S. Pat. No. 5,311,938 bends with the end of sealing element and makes contact with the opposing wall to bridge the sealing gap with the idea that the rubber is prevented from extruding axially. While serviceable this design has issues in releasing which sometimes led to the packer getting stuck even when the sealing element extended and relaxed but the extrusion ring did not relax.

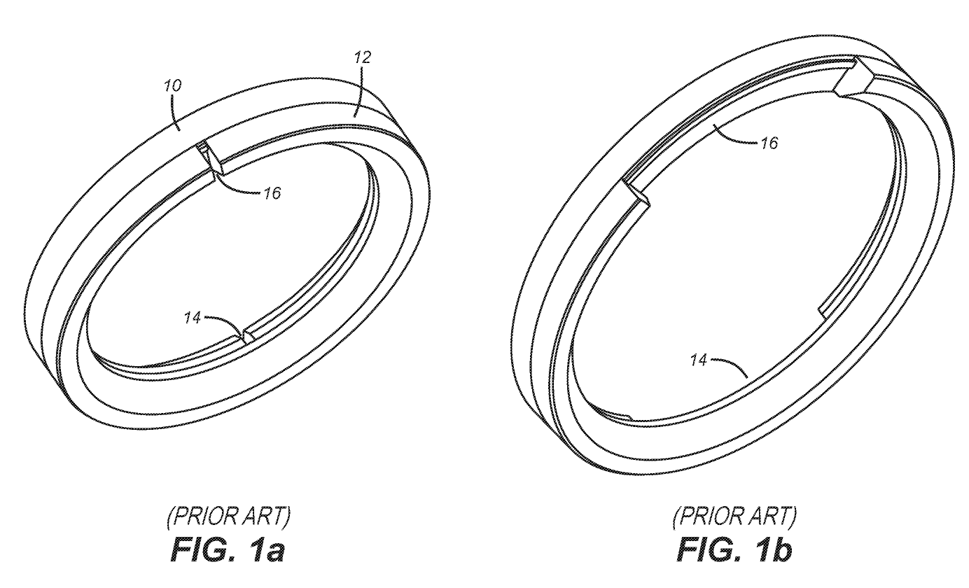

FIG. 1a shows another extrusion barrier ring assembly using a pair of split rings 10 and 12 that have splits 14 and 16 respectively. The rings 10 and 12 are keyed to prevent relative rotation to keep the splits 14 and 16 spaced 180 degrees apart. When the sealing element is axially compressed these rings are moved out radially on a ring with a taper to contact the surrounding tubular as the gaps 14 and 16 get substantially larger. The enlarged gaps still created issues for rubber extrusion for the sealing element particularly in high pressure high temperature applications. With pressure differentials of over 10,000 PSI extrusion past assemblies shown in FIGS. 1a and 1b was still a significant concern.

The present invention addresses this concern in high temperature and high pressure applications by the creation and application of a 360 expandable ring design featuring alternating inner and outer radially oriented slits. For low and medium reach the expandable ring rides up a wedge ring until the surrounding tubular or the open hole borehole is contacted. In high reach application an outer expandable ring of a similar design rides on an opposite side of a wedge ring until forced into supporting contact of the principal expandable ring pushing the principal expandable ring against the surrounding borehole or tubular. The expandable rings can be made of Teflon or another flexible material that is sufficiently resilient while resistant to high temperatures and well fluids.

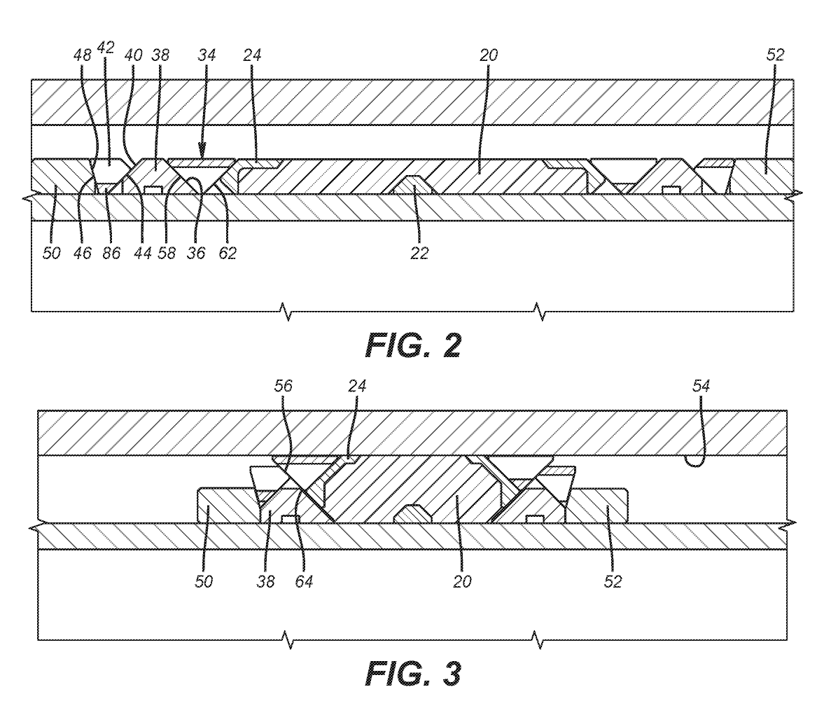

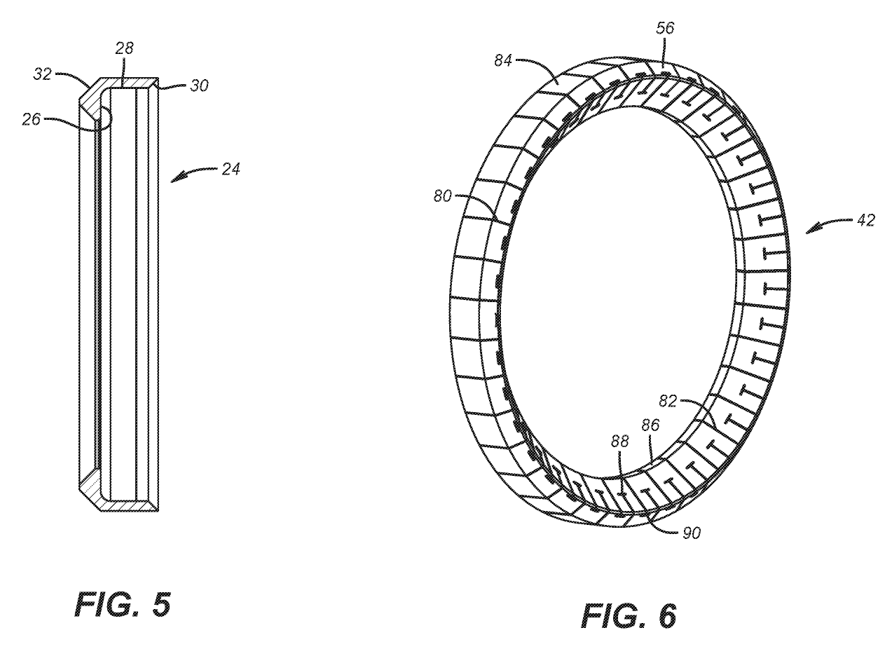

FIG. 2 shows the basic layout for a long reach application. Sealing element 20 can optionally have a filler ring 22 in the center. The assemblies on opposed ends of the element 20 are preferably mirror image and so they will be described only for one side with the understanding that the opposed side is an identical mirror image. An extrusion barrier in the form of an expanding ring 24 is attached to the element 20 and is sufficiently flexible to move with it. FIG. 5 shows a section view of the bonded expanding ring 24. Ring 24 prevents the sealing element from escaping the cut slots of ring 34 and better conformability to the casing inside diameter or the borehole wall 54. It could be made of non-metallic material or very ductile metallic material.

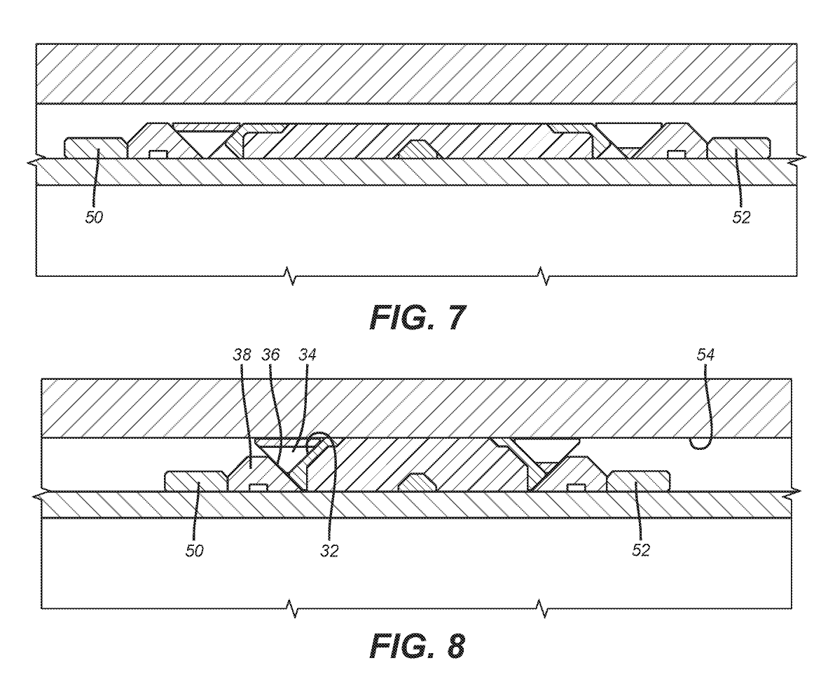

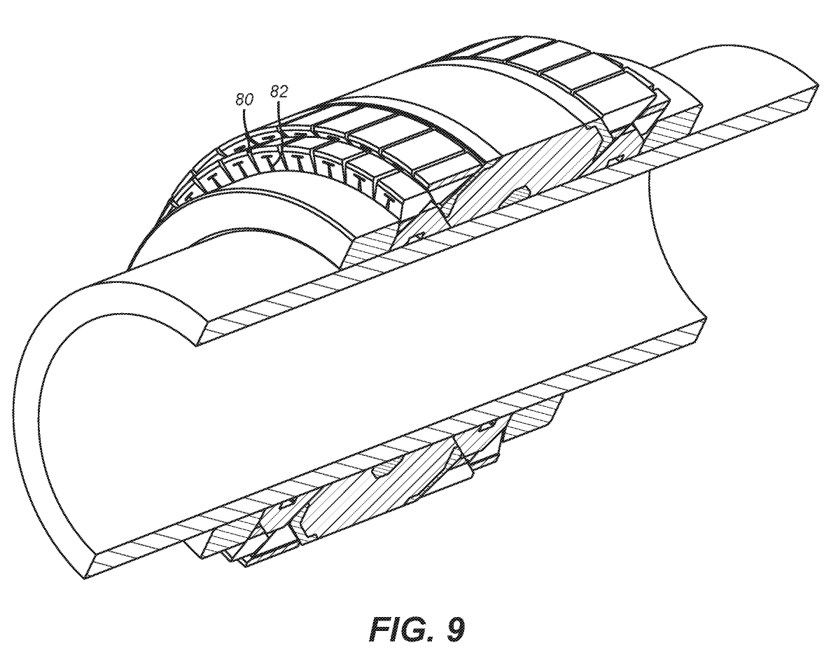

It has sides 26, 28 and 30 against seal 20 and a ramp surface 32. Inner expandable ring 34 rides on ramp 32 on one side and ramp 36 of ramp ring 38. Ring 38 has another ramp 40 opposite ramp 36 on which rides outer expandable ring 42. Ramp 44 on outer expandable ring 42 rides on ramp 40 of ring 38. On the other side ramp 46 rides on ramp 48 of setting ring 50. The setting sequence results from relative movement between rings 50 and 52. Usually one is moving while the other is stationary. FIG. 3 shows the result of the relative movement. The element 20 is up against the borehole wall or surrounding tubular 54 as is the adjacent ring 24. Ring 38 has shifted toward element 20 by going under ring 24 that is continuously supported for 360 degrees by expandable ring 34. Inner expandable ring 34 has moved against the borehole wall or tubular 54 by sliding along opposed ramp surfaces 32 and 36. The outer expandable ring 42 has moved out on ramps 40 and 48 until its surface 56 engages surface 58 of inner expandable ring 34 to wedge it against the borehole wall or tubular 54. The new relative position of rings 50 and 52 can be releasably locked to hold the FIG. 3 set position until it is time to retrieve the packer. The abutting of rings 42 and 34 allows ring 34 to travel further out radially than in the FIG. 8 embodiment which is otherwise the same except outer expandable ring 42 is not shown because the required radial movement in FIG. 8 is much less than in FIG. 3. As a result in FIG. 8 the inner expandable ring 34 simply rides out on ramps 36 and 32 until contact is made with the borehole wall or tubular 54. Ring 38 abuts ring 50 and does not go under ring 24 as in FIG. 3. The reach in FIG. 8 is much shorter than in FIG. 3.

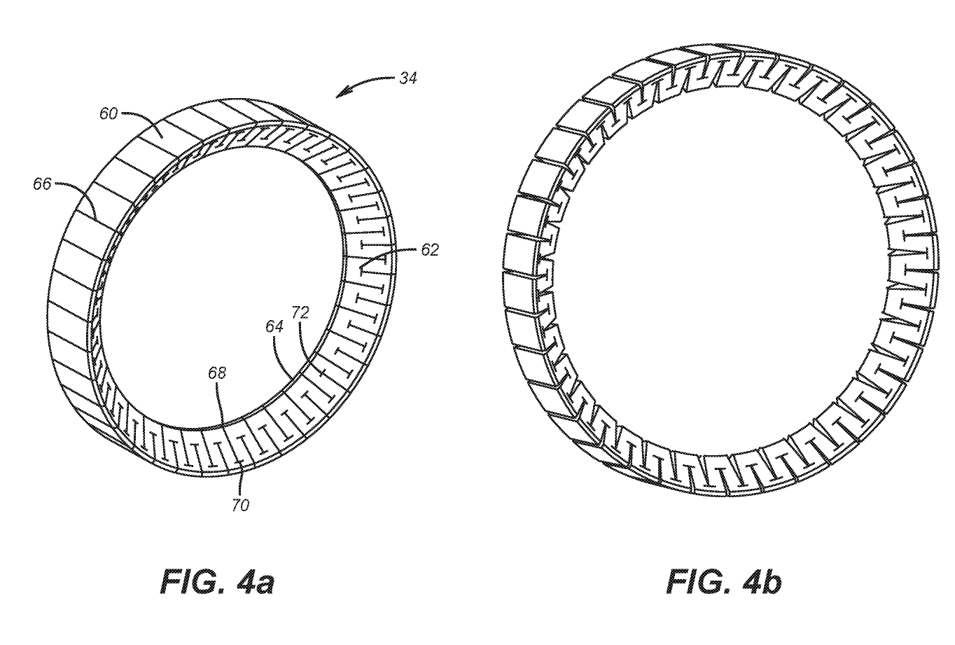

FIGS. 4a and 4b show ring 34 in the run in and the set positions respectively. An outer face 60 continues along a tapered surface 62 to internal surface 64 seen as the inner parallel surface of a trapezoidal section in FIG. 3 and a continuous line in perspective in the views of FIG. 4. Slots 66 circumferentially alternate with slots 68 and are radially oriented to preferably align with the center of ring 34. Slots 66 start at the outer face 60 and slots 68 start at the surface 64. Slots 68 end in a transverse segment 70 and slots 66 end in a transverse segment 72. The transverse segments are there to limit stress as the slots 66 and 68 open up as the sealing element 20 is set against the borehole wall or tubular 54. Outer expandable ring 42 is shown in perspective in FIG. 6 and essentially has a similar slot configuration as described in FIGS. 4a and 4b with the section profile being different as shown in FIGS. 2 and 3. However it is the same continuous 360 degree design for the ring 42 as the ring 34 with alternating slots with transverse end portions that start from opposing ends of the ring structure. Specifically, slots 80 and 82 start respectively at outer face 84 and inner dimension 86 seen as a ring in FIG. 6 and as a flat in section in FIG. 2. The slots extend radially and preferably in alignment with the center of ring 42. Alternatively the slots can extend axially but radially is preferred. At the respective ends of slots 80 and 82 are transverse ends 88 and 90. As ring 42 expands from the FIG. 2 to the FIG. 3 position, the slots 80 and 82 open up to allow the diameter to increase until surface 56 hits surface 58 of inner expandable ring 34 as shown in FIG. 3.

Rings 34 and 40 can be Teflon, metallic, composite to name a few examples. The shape can be created with lasers or wire EDM fabrication methods. Although in FIGS. 2 and 3 a single inner ring 34 and outer ring 40 are illustrated multiple pairs of such rings that function in the same way can be used. In the case of FIGS. 7 and 8 multiple pairs of expandable ring 36 and ramp ring 38 can be used and they can operate in the same manner as illustrated for a single such pair of rings as shown in FIGS. 7 and 8. The 360 degree design for rings 34 and 42 combined with solid expandable ring 24, which prevents the rubber element 20 from escaping through cut slots in ring 34 and improves conformance to tubular or borehole inside diameter dramatically reduces extrusion of seal 20 even though the slots expand for the larger set position. The 360 degree feature of the rings 34, 42 and 24, if used, limit the extrusion gaps and allow a given sealing system 20 to be serviceable in higher pressure differential applications without extrusion risk. The design is modular so that it is simple to switch between the FIG. 2 and FIG. 7 configurations for different applications. The ring 42 backing up the ring 34 wedges ring 34 in the FIG. 3 set position wedges in ring 34 to hold it in position against high differential pressures that can exceed 10,000 PSI. The slot ends can be a transverse slot or an enlarged rounded end or other shape that limit stress concentration at the ends of the radial slots.

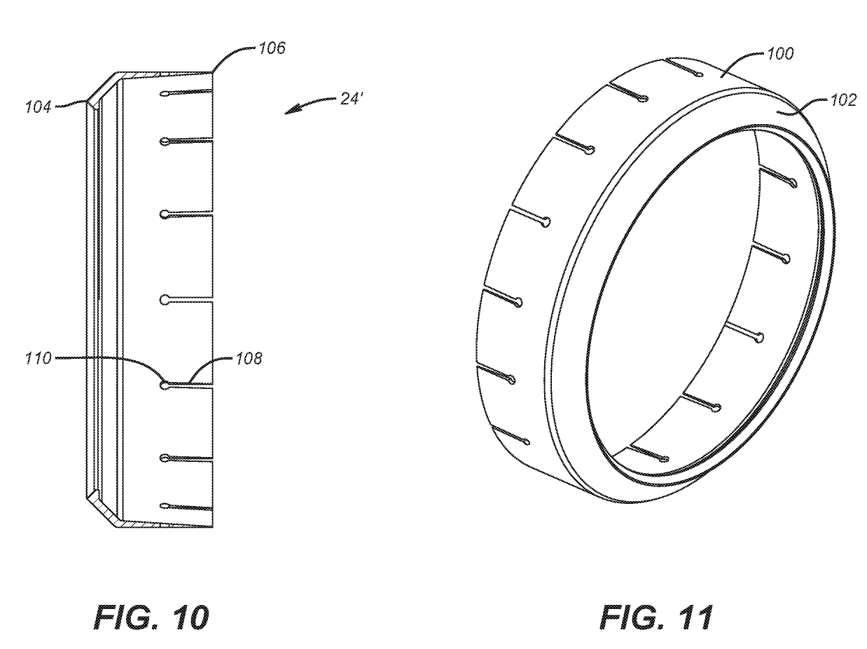

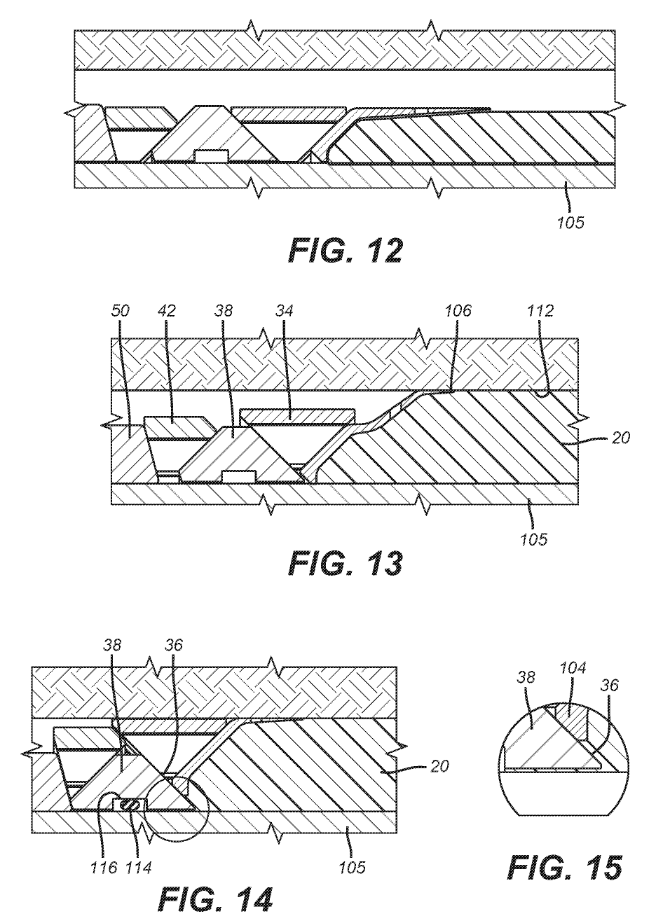

A preferred design for backup ring 24′ is shown in FIGS. 10 and 11. It features a cylindrically shaped component 100 that transitions to a tapered segment 102 that ends at an enlarged end 104 that turns inwardly toward mandrel 105 shown in FIG. 8. The cylindrically shaped component is tapered to its minimum thickness at end 106. An array of slots 108 start at end 106 and extend generally axially to rounded ends 110 that are there to reduce stress concentration at the ends of slots 108. The slots 108 are preferably equally spaced and of uniform width and length. The preferred length is less than half of the axial length of the cylindrically shaped component 100. The tapered section allows greater flexibility near end 106 during the setting as shown in FIG. 13 such that end 106 and some of the adjacent cylindrically shaped segment 100 that has slots 108 makes initial contact with the surrounding borehole wall 112. As the setting movement continues the cylindrically shaped component 100 continues to make contact with the borehole wall 112 past the rounded ends 110 of slots 108 so that a slot free segment of the cylindrically shaped component then makes contact with the borehole wall 112. The slots 108 make the end 106 more flexible to allow early initial movement toward the borehole wall 112 with reduced radial pushing force so that the end 106 is preferably already in contact with the borehole wall 112 before the internal pressure of the sealing assembly 20 get very high as it is axially compressed to be radially extended against the surrounding borehole wall 112. On further axial compression of the sealing assembly 20 the non-slotted portion of the cylindrically shaped segment 100 makes contact with borehole wall 112 to close off axial slots 108 as potential extrusion paths. As that happens the tapered segment 102 is backed up by ring 34 that has a tapered surface 62 that conforms to the angle of the tapered segment 102. Enlarged end 104 serves as a stiffening rib near the mandrel 105 but is driven away from mandrel 105 in the set position of FIGS. 14 and 15. There is a path for the material of seal assembly 20 to pass under wedge ring 38 until that path is closed with a seal 114 against mandrel 105 in groove 116. During the setting the enlarged end 104 contacts wedge ring 38 and rides up inclined surface 36 of wedge ring 38.

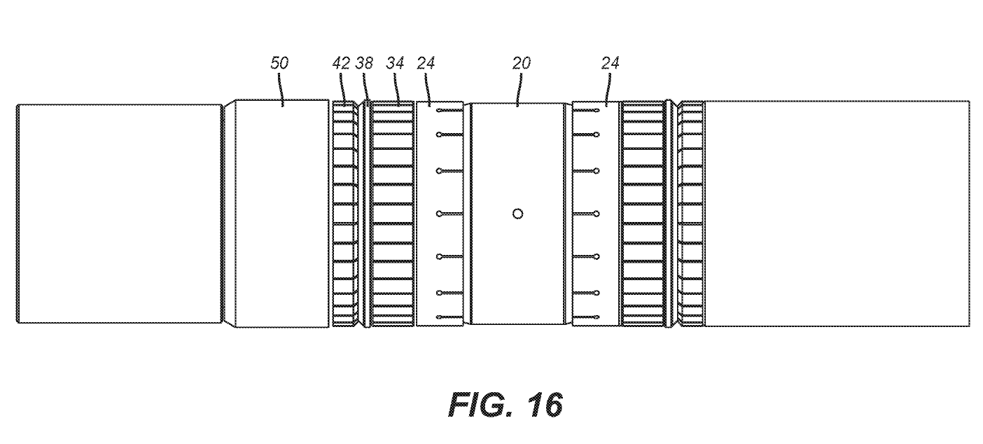

Backup ring 24′ performs markedly better than backup ring 24 in high pressure and high temperature applications. One of the reasons is that there are slots 108 and a tapered section near end 106. This allows early movement of end 106 against the borehole wall 112 with the onset of application of the compressive setting force. The slotted portion of the cylindrically shaped segment 100 can establish itself against the borehole wall 112 before the internal pressure on the sealing element assembly 20 increases significantly so that extrusion into the slots 108 can start. While the seal material fills the slots 108 those slots get closed off quickly before the internal pressure in the seal material 20 increases appreciably as the set position is achieved. The contact of the non-slotted portion of the cylindrically shaped component 100 with the borehole wall provided strength due to absence of slots 108 and closure at the rounded slot ends 110 against axial extrusion along the borehole wall 105. At the same time the seal 114 in groove 116 in wedge ring 38 prevents extrusion along mandrel 105 even though some small part of the seal assembly 20 does move axially under the wedge ring 38 as shown in FIGS. 14 and 15. FIG. 16 shows the arrangement can be symmetrical about opposed ends of the sealing element assembly 20.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

The above description is illustrative of the preferred embodiment and many modifications may be made by those skilled in the art without departing from the invention whose scope is to be determined from the literal and equivalent scope of the claims below:

We claim:

1. An extrusion barrier assembly for a mandrel mounted sealing element assembly of a borehole isolation device, comprising:
at least one extrusion barrier ring surrounding the mandrel and initially abutting and radially overlapping at least one end of the sealing element assembly, said extrusion barrier ring comprising a cylindrically shaped segment which initially overlaps the sealing element assembly and features at least one axially oriented slot.

2. The assembly of claim 1, wherein:
said at least one slot is shorter than an axial length of said cylindrically shaped segment.

3. The assembly of claim 2, wherein:
said at least one slot extends for less than half the axial length of said cylindrically shaped segment.

4. The assembly of claim 2, wherein:
said at least one slot extends to an end of said cylindrically shaped segment.

5. The assembly of claim 4, wherein:
said cylindrically shaped segment narrows in section toward said end.

6. The assembly of claim 2, wherein:
said cylindrically shaped segment tapers in section for an axial length coincident with said at least one slot.

7. The assembly of claim 2, wherein:
said at least one slot comprises a plurality of axially extending slots from an end of said cylindrically shaped segment.

8. The assembly of claim 7, wherein:
said slots are evenly spaced and end in said cylindrically shaped segment with a rounded end.

9. The assembly of claim 5, wherein:
said end makes initial contact with the borehole before the balance of said cylindrically shaped segment.

10. The assembly of claim 1, wherein:
said ring comprising a tapered segment extending from said cylindrically shaped segment and toward said mandrel where said tapered segment ends in a thicker portion for stiffness.

11. The assembly of claim 10, wherein:
said tapered segment selectively movable axially to contact a wedge ring as an intermediate ring between said tapered segment and said wedge ring is forced out radially away from the mandrel.

12. The assembly of claim 11, wherein:
said wedge ring having opposed tapered sides to a peak spaced apart from the mandrel, said thicker portion of said tapered segment moving away from the mandrel along one of said opposed tapered sides as said cylindrically shaped segment makes contact with the borehole.

13. An extrusion barrier assembly for a mandrel mounted sealing element assembly of a borehole isolation device, comprising:
at least one extrusion barrier ring surrounding the mandrel and initially abutting and radially overlapping at least one end of the sealing element assembly, said extrusion barrier ring comprising a cylindrically shaped segment which initially overlaps the sealing element assembly and features a tapered cross-section that narrows in a direction toward said end.

14. The assembly of claim 13, wherein:
said end makes initial contact with the borehole before the balance of said cylindrically shaped segment.

15. The assembly of claim 14, wherein:
said ring comprising a tapered segment extending from said cylindrically shaped segment and toward said mandrel where said tapered segment ends in a thicker portion for stiffness.

16. The assembly of claim 15, wherein:
said tapered segment selectively movable axially to contact a wedge ring as an intermediate ring between said tapered segment and said wedge ring is forced out radially away from the mandrel.

17. The assembly of claim 16, wherein:
said wedge ring having opposed tapered sides to a peak spaced apart from the mandrel, said thicker portion of said tapered segment moving away from the mandrel along one of said opposed tapered sides as said cylindrically shaped segment makes contact with the borehole.

18. The assembly of claim 15, further comprising:
at least one slot is shorter than an axial length of said cylindrically shaped segment.

19. The assembly of claim 18, wherein:
said at least one slot extends for less than half the axial length of said cylindrically shaped segment.

20. The assembly of claim 19, wherein:
said at least one slot extends to an end of said cylindrically shaped segment.

21. The assembly of claim 20, wherein:
said at least one slot comprises a plurality of axially extending slots from an end of said cylindrically shaped segment.

22. The assembly of claim 21, wherein:
said slots are evenly spaced and end in said cylindrically shaped segment with a rounded end.

23. A treatment method using borehole isolation device comprising an extrusion barrier assembly for a mandrel mounted sealing element assembly, comprising:
providing at least one extrusion barrier ring surrounding the mandrel and initially abutting and radially overlapping at least one end of the sealing element assembly, said extrusion barrier ring comprising a cylindrically shaped segment which initially overlaps the sealing element assembly and features at least one axially oriented slot;
performing a treatment against said sealing element assembly into at least one formation adjacent the borehole.

24. The method of claim 23, comprising:
making said at least one slot shorter than an axial length of said cylindrically shaped segment.

25. The method of claim 24, comprising:
extending said at least one slot for less than half the axial length of said cylindrically shaped segment.

26. The method of claim 24, comprising:
extending said at least one slot to an end of said cylindrically shaped segment.

27. The method of claim 26, comprising:
narrowing said cylindrically shaped segment in section toward said end.

28. The method of claim 24, comprising:
tapering said cylindrically shaped segment in section for an axial length coincident with said at least one slot.

29. The method of claim 24, comprising:
providing as said at least one slot a plurality of axially extending slots from an end of said cylindrically shaped segment.

30. A treatment method using borehole isolation device comprising an extrusion barrier assembly for a mandrel mounted sealing element assembly, comprising:
providing at least one extrusion barrier ring surrounding the mandrel and initially abutting and radially overlapping at least one end of the sealing element assembly, said extrusion barrier ring comprising a cylindrically shaped segment which initially overlaps the sealing element assembly and features a tapered cross-section that narrows in a direction toward said end;
performing a treatment against said sealing element assembly into at least one formation adjacent the borehole.

31. The method of claim 30, wherein:
making initial contact with said end to the borehole before the balance of said cylindrically shaped segment.

32. The method of claim 31, wherein:
providing a tapered segment on said ring extending from said cylindrically shaped segment and toward said mandrel where said tapered segment ends in a thicker portion for stiffness.

33. The method of claim 32, wherein:
configuring said tapered segment to be selectively movable axially to contact a wedge ring as an intermediate ring between said tapered segment and said wedge ring is forced out radially away from the mandrel.

34. The method of claim 33, wherein:
providing opposed tapered sides on said wedge ring to a peak spaced apart from the mandrel, said thicker portion of said tapered segment moving away from the mandrel along one of said opposed tapered sides as said cylindrically shaped segment makes contact with the borehole.

35. The method of claim 30, wherein:
performing fracturing as said treatment.

36. The method of claim 23, wherein:
performing fracturing as said treatment.
